(19) United States
(12) Patent Application Publication
(10) Pub. No.: US 2007/0150405 A1
(43) Pub. Date: Jun. 28, 2007

(54) EXCHANGE-BASED AUCTION FOR OFFERINGS

(76) Inventors: Joel Kenneth Greenberg, Gladwyne, PA (US); James Joseph Ramp, Holland, PA (US)

Correspondence Address: DLA PIPER US LLP, P. O. BOX 9271, RESTON, VA, 20195, US

(21) Appl. No.: 11/557,847

(22) Filed: Nov. 8, 2006

Related U.S. Application Data
(60) Provisional application No. 60/734,792, filed on Nov. 9, 2005.

(51) Int. Cl. G06Q 40/00

(52) U.S. Cl. 705/37

(57) ABSTRACT

A method and system are disclosed for determining the public offering price and the allocation of securities by an exchange-based auction conducted by the underwriters and the issuers of the securities. The exchange-based auction is conducted through the apparatus of a securities exchange such that all qualified individual and institutional investors may place bids in the exchange-based auction and investors submitting valid bids will have an equal opportunity to receive an allocation of securities.

### CROSS-REFERENCE TO RELATED APPLICATIONS

This application receives the benefit of priority from U.S. provisional application Ser. No. 60/734,792 entitled “Exchange Based Dutch Auction For Offerings”, filed on Nov. 9, 2005. The entire contents of which is herein incorporated by reference in its entirety.

### FIELD OF THE INVENTION

The invention relates generally to the field of financial transactions, and more specifically to an exchange-based auction for offerings.

### BRIEF DESCRIPTION OF THE DRAWINGS

Reference is made to the attached drawing, wherein elements having the same reference designations represent like elements throughout and wherein:

FIG. 1 is a block diagram illustrating an embodiment of an exchange-based auction for offerings system for determining a public offering and the allocation of securities.

FIG. 2 is a flow diagram illustrating an embodiment of an exchange-based auction method for determining a public offering price.

FIG. 3 is a flow diagram illustrating an embodiment of exchange-based auction method for determining the allocation of securities in a public offering.

### DETAILED DESCRIPTION OF SEVERAL EMBODIMENTS

It will be appreciated that the following description is intended to refer to specific embodiments of the invention and is not intended to define or limit the invention, other than in the appended claims. The embodiments include methods and apparatuses for conducting an exchange-based auction for offering of securities. In the embodiments herein, the methods and apparatuses are utilized for the pricing of primary and secondary public offerings of securities, however, the invention should not in any way be construed as being limited in utility to primary and secondary securities offerings. For example, the methods and apparatuses herein may also be utilized for the pricing of overnight/aftermarket block trades of securities such as those related to S-3 “shelf” registration statements. Further, one skilled in the art will recognize the utility of the invention for various other financial transactions that may, for example, include an exchange-based auction component for securities, stocks, bonds, other financial instruments, commodities, goods, services or the like (herein, collectively, “securities”).

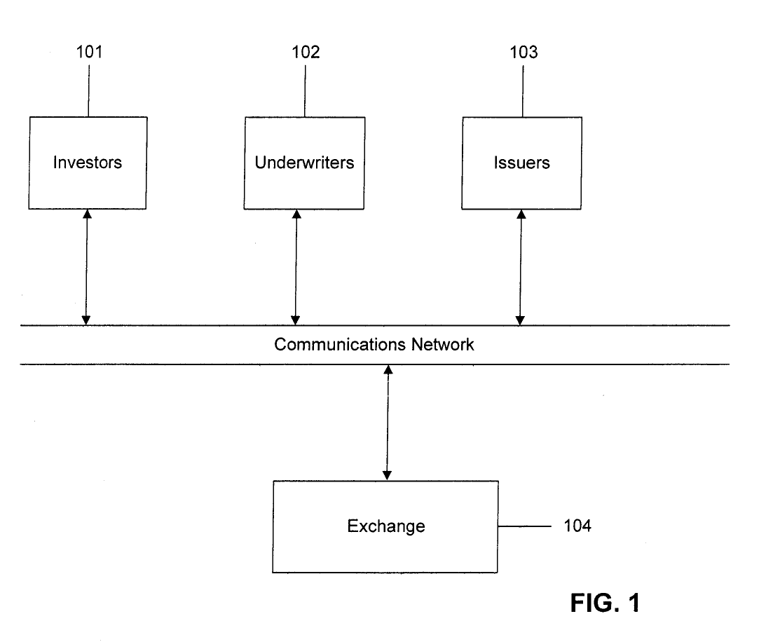

FIG. 1 illustrates in block diagram form an embodiment of an exchange-based auction for offerings system for determining a public offering and the allocation of securities wherein investors 101, underwriters 102 and/or issuers 103 conduct an exchange-based auction centered at an exchange, and via a communications network.

As such, in various embodiments a method for determining the public offering price and the allocation of securities, both initial and secondary and for both equity and debt, by an exchange-based auction conducted by the underwriters 102 and the issuer 103 of the securities is disclosed. In one embodiment, the exchange-based auction is conducted through the apparatus of a securities exchange such that all qualified individual and institutional investors 101 may place bids in the exchange-based auction and investors 101 submitting valid bids will have an equal opportunity to receive an allocation of securities. Before an SEC registration statement relating to an offering becomes effective, but after a preliminary prospectus is available, the issuer 103 of the securities opens an auction wherein the underwriters 102 and participating dealers will solicit bids, from prospective investors through the trading apparatus of an exchange 104. As used herein, “exchange” refers to (i) a U.S. or foreign marketplace for securities or any financial instruments, including without limitation, all exchanges, organizations, associations or groups of persons, whether incorporated or unincorporated, that constitute, maintain or provide a marketplace or facilities for bringing together buyers and sellers of securities, futures and/or other financial instruments, for bringing together orders for securities, futures and/or financial instruments of multiple buyers and sellers, or for otherwise performing with respect to securities, futures and/or other financial instruments the functions commonly performed by a stock exchange, commodity exchange, trading center, alternative trading system, trade reporting system, alternative display facility, automated trading center, electronic communications network or other similar facility as those terms are respectively generally understood; (ii) all U.S. and foreign quotation and trade reporting systems or any other similar facilities or market centers where order to buy and sell securities, futures and/or other financial instruments interact with each other; (iii) all exchanges, quotation systems, trading centers, alternative trading systems, alternative display facilities, automated trading centers, electronic communications networks or other facilities and all market facilities maintained by any of the foregoing; and (iv) all U.S. and foreign over-the-counter markets, including, without limitation, all in-person, telephone, computer or other electronic networks that connect buyers and sellers of securities, futures and/or other financial instruments. As one example, the exchange 104 may be physical, like the New York Stock Exchange, or electronic, like NASDAQ. In the case of an electronic exchange, various traders generally input bids and offers or, in this case, non-binding indications of interest regarding participation in an offering, through a computerized order management system that routes such indications to the exchange 105 and eventually to the underwriter 102 conducting the auction.

In one embodiment, the indications go into the underwriter's “book”, akin to how orders are routed to a specialist on an exchange 104. In a typical exchange, specialists hold themselves out as being willing to buy or sell a particular security for a spread (profit). For example, orders come into the exchange 104 and are routed to the specialist responsible for that security. All the orders that a specialist receives are called his “book”. Orders generally rest on the book until filled unless they are otherwise cancelled. Likewise, an underwriter 102 would be the destination of the indications of interest from the bidding or pre-offering of securities flowing into an exchange and the underwriter 102 would collect those indications in a book, applying the principles of an auction to determine what the clearing price and offering price ought to be, as described below. In the embodiment described below, the auction is a Dutch auction, although any type of auction may be employed. The underwriter may determine the duration of the auction period and/or review the bids in conjunction with the issuer. At the close of the auction, “winning” bids are filled and the offering is complete.

A “bid” as described in this embodiment specifies the number of shares of the issuer's common stock the potential investor proposes to purchase in an indication of interest and the price the potential investor is willing to pay for the shares. These bids may be above or below the range set forth by the underwriters. In one embodiment, the underwriters 102 may set a minimum bid size. For example, the minimum size of any bid may be 100 shares.

Prior to the time that a registration statement filed with the SEC becomes effective, the offered shares may not be sold, nor may offers to buy be accepted. A bid received by the underwriters 102 or a dealer may involve no obligation or commitment of any kind prior to the closing of the auction. Bids may also be modified or revoked at any time prior to the closing of the auction. The underwriter 102 and issuer 103 would also have the discretion to accept or reject bids at the close of the auction. Further, the issuer 103 would always have the right to withdraw an offering.

In one embodiment, a scoring system is employed whereby the issuer 103, underwriter 102 and/or a quantitative expert rate the quality of the indications of interest received from bidders. The scoring system may include qualitative analysis, which may include the questions described below and quantitative analysis, which may include the latest quantitative and statistical techniques described in the leading academic research at the time. For example, the underwriter 102 or issuer 103 may have bidders complete a questionnaire at the time of their indication of interest. The questions may include topics such as, for example, how long the bidder intended to hold the offered security, the bidder's net worth, the general investment objectives of the bidder, whether or not the bidder has attended the issuer's road show presentation, whether the current investment meets the bidder's current portfolio investment criteria, comparable securities held in the bidder's investment portfolio, what analysis, if any, has the bidder performed with respect to the offering, what percentage of the bidder's holdings would the offered security comprise or the like. In conjunction with the underwriter 102, the issuer 103 may choose to weight the questions as desired. The questionnaire would then result in a bidder receiving a score allowing comparison of the “quality” of a bid received from one bidder versus another. For example, the issuer 103 would potentially be able to determine whether a bid received from a day trader making $75,000 a year who is relatively unsophisticated or a bid received from a sophisticated institutional investor 101 with billions under management would generally be better suited to handle the market risks of their particular offering. As such, the method of combining an investor-vetting scoring system with the opening of bidding to the relatively large investor market associated with a particular exchange contributes to a more stable market for the offered security.

Alternatively, the scoring system may be substituted or modified to incorporate other predetermined investor criteria including (1) the elimination of bidders below a predetermined threshold (e.g., income, bid amount, etc.) and (2) permissions to allow bidders in for the percentage of their bid equal to their score on the questionnaire. For example, if a bidder scores a 71 out of 100 on the questionnaire and bids for 100,000 shares, then the bid may be accepted into the book for 71,000 shares. Another alternative is that bidders may be allowed to input tiered bids based on their questionnaire or other criteria. For example, a bidder may be allowed to place bids such as 100,000 shares at $15, 150,000 at $10, and the like based on their questionnaire responses. Further, the scoring system may be employed utilizing an off-exchange auction such as a live auction or an auction conducted via telephone, electronic mail, a closed network or the like.

Following the application of an exchange-based Dutch auction to the bidding process, prospective investors may receive, via the exchange apparatus or otherwise, a notice indicating the proposed effective date of the registration statement for the offering. For an off-exchange auction, the prospective investors 101 may receive notice via telephone, electronic mail, letters or other means. In one embodiment, notice may be given, for example, two business days prior to the registration statement being declared effective. After the registration statement relating to the offering has become effective, potential investors 101 who have submitted bids to the underwriters 102 or a dealer are contacted by the underwriters in charge of the bidding process. Potential investors may be advised that the registration statement has been declared effective and that the auction may close at a predetermined time following effectiveness. As such, bids may continue to be accepted in the time period after the registration statement is declared effective but before the auction closes. Bidders may also withdraw their bids in the time period following effectiveness but before the close of the auction.

In one embodiment, the underwriters 102 may require that bidders reconfirm the bids that they have submitted in the offering and/or the answers they have submitted for the questionnaire. For example, reconfirmed bids may be required if:
more than 15 business days have elapsed since the bidder submitted its bid in the offering;
there is a material change in the prospectus that requires recirculation of the prospectus by the issuer and the underwriters; or
the initial public offering price is a predetermined percentage above a preset high end of a price range for the shares or a predetermined percentage below a preset low end of a price range. In this event, the underwriters 102 may circulate a revised preliminary prospectus with their requests for reconfirmation.

If a reconfirmation of bids is required, the underwriters 102 may send an electronic notice via the securities exchange 105 apparatus (for an exchange-based auction) to everyone who has submitted a bid notifying them that they must reconfirm their bids by contacting the underwriters or participating dealers with which they have their brokerage accounts. For example, bidders may have a set period of time to reconfirm their bids before the auction is closed. If any of the bids are not reconfirmed within the set time period, the issuers and the underwriters may disregard those bids in the auction, and they may be deemed to have been withdrawn. Further, if prior to the date on which the registration statement becomes effective, there is a change, for example, in the price range or the number of shares to be sold in the offering, the issuer 103 and the underwriters 102 may require the prospective bidders to reconfirm their bids.

Following the closing of the auction, the underwriters 102 determine the highest price at which all of the shares offered, including shares that may be purchased by the underwriters 102 to cover any overallotments, may be sold to potential investors 101. This price, which is called the “clearing price,” is determined based on the results of all valid bids at the time the auction is closed. The public offering price, which is determined by the underwriters 102 and the issuer 103 and which may be based at least in part on the clearing price (and other available data), determines the allocation of shares to potential investors 103, with all valid bids submitted at or above the public offering price receiving a pro rata portion of the shares bid for during the auction. In one embodiment, the underwriters 102 may accept successful bids by sending notice of acceptance after the auction closes and a public offering price has been determined. Once the auction closes and a clearing price is set, the underwriters 102 or a participating dealer accept the bids from those bidders whose bids are at or above the public offering price, but may allocate to a prospective investor fewer shares than the number included in the investor's bid.

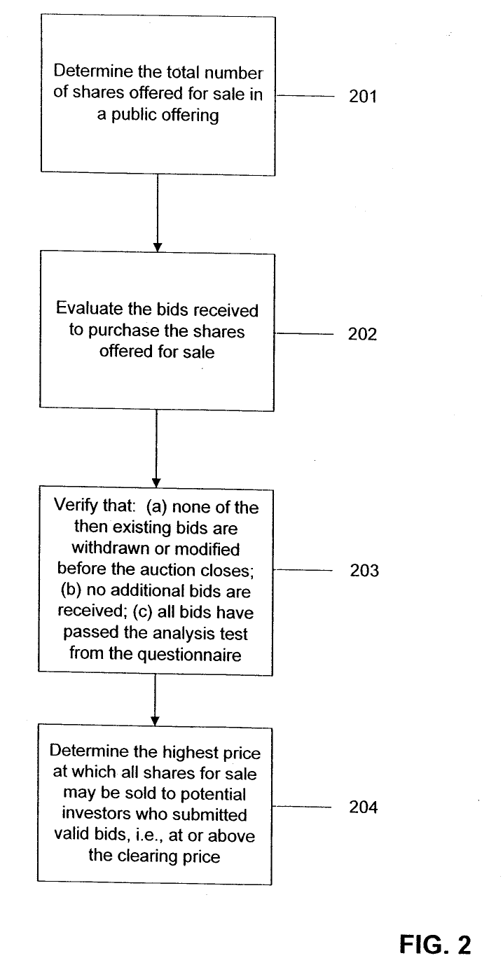

FIG. 2 is a flow diagram illustrating an embodiment of an exchange-based Dutch auction method for determining a public offering price. The following example illustrates how the public offering price is determined through the auction process:

In operation 201, a company determines the total number of shares offered for sale in a public offering. For example, Company X offers to sell 1,500 shares in its public offering through, for example, an exchange-based auction process, an off-exchange auction or an overnight/aftermarket auction. In operation 202, the underwriter evaluates the bids received to purchase the offered shares. For example, the underwriter, on behalf of Company X, receives five bids to purchase, all of which are kept confidential until the auction closes.

The first bid is to pay $10.00 per share for 1,000 shares. The second bid is to pay $9.00 per share for 100 shares. The third bid is to pay $8.00 per share for 900 shares. The fourth bid is to pay $7.00 per share for 400 shares. The fifth bid is to pay $6.00 per share for 800 shares.

In operation 203, assuming that none of these bids are withdrawn or modified before the auction closes, and assuming that no additional bids are received, and assuming all bids have passed the analysis test from the questionnaire, the clearing price used to determine the public offering price, in operation 204, would be $8.00 per share. This is the highest price at which all 1,500 shares offered may be sold to potential investors who have submitted valid bids. However, the shares may be sold at a price below $8.00 per share based on negotiations between Company X and the underwriter.

If the public offering price is the same as the $8.00 per share clearing price, the underwriter would accept bids at or above $8.00 per share. Because 2,000 shares were bid for at or above the clearing price, each of the three potential investors who bid $8.00 per share or more would receive 75% (1,500 divided by 2,000) of the shares for which bids were made. The two potential investors whose bids were below $8.00 per share would not receive any shares in this example.

If the public offering price is $7.00 per share, the underwriter would accept bids that were made at or above $7.00 per share. No bids made at a price of less than $7.00 per share would be accepted. The four potential investors with the highest bids would receive a pro rata portion of the 1,500 shares offered, based on the 2,400 shares they requested, or 62.5% (1,500 divided by 2,400) of the shares for which bids were made. The potential investor with the lowest bid would not receive any shares in this example.

Because bids that are reduced on a pro rata basis may be rounded down to round lots, a potential investor may be allocated less than the pro rata percentage of the shares bid for. Thus, if the pro rata percentage was 75%, the potential investor who bids for 200 shares may receive a pro rata allocation of 100 shares (50% of the shares bid for), rather than receiving a pro rata allocation of 150 shares (75% of the shares bid for).

The following table illustrates the example described above, after rounding down any bids to the nearest round lot in accordance with the allocation rules described below, and assuming that the initial public offering price is set at $8.00 per share. The table also assumes that these bids are the final bids, and that they reflect any modifications that have been made to reflect any prior changes to the offering range, and to avoid the issuance of fractional shares.

Initial Public Offering of Company X

| | | | | Auction results | | | |
|---|---|---|---|---|---|---|---|
| | Bid information | | | | Approximate | | |
| | | Cumulative | | | Allocated | | |
| | Shares | Shares | Bid | Shares | Requested | Clearing | Amount |
| | Requested | Requested | Price | Allocated | Shares | Price | Raised |
| Clearing Price | 1,000 | 1,000 | $10.00 | 700 | 75% | $8.00 | $5,600 |
| | 100 | 1,100 | $9.00 | 100 | 75% | $8.00 | $800 |
| | 900 | 2,000 | $8.00 | 700 | 75% | $8.00 | $5,600 |
| | 400 | 2,400 | $7.00 | 0 | 0% | — | |
| | 800 | 3,200 | $6.00 | 0 | 0% | — | |
| Total: | | | | 1,500 | | | $12,000 |

Bidders receiving a pro rata portion of the shares they bid for generally receive an allocation of shares on a round-lot basis, rounded to multiples of 100 or 1,000 shares, depending on the size of the bid. No bids are rounded to a round lot higher than the original bid size. Because bids may be rounded down to round lots in multiples of 100 or 1,000 shares, some bidders may receive allocations of shares that reflect a greater percentage decrease in their original bid than the average pro rata decrease. Thus, for example, if a bidder has confirmed a bid for 200 shares, and there is an average pro rata decrease of all bids of 30%, the bidder may receive an allocation of 100 shares (a 50% decrease from 200 shares) rather than receiving an allocation of 140 shares (a 30% decrease from 200 shares). In addition, some bidders may receive allocations of shares that reflect a lesser percentage decrease in their original bid than the average pro rata decrease. For example, if a bidder has submitted a bid for 100 shares, and there is an average pro rata decrease of all bids of 30%, the bidder may receive an allocation of all 100 shares to avoid having the bid rounded down to zero.

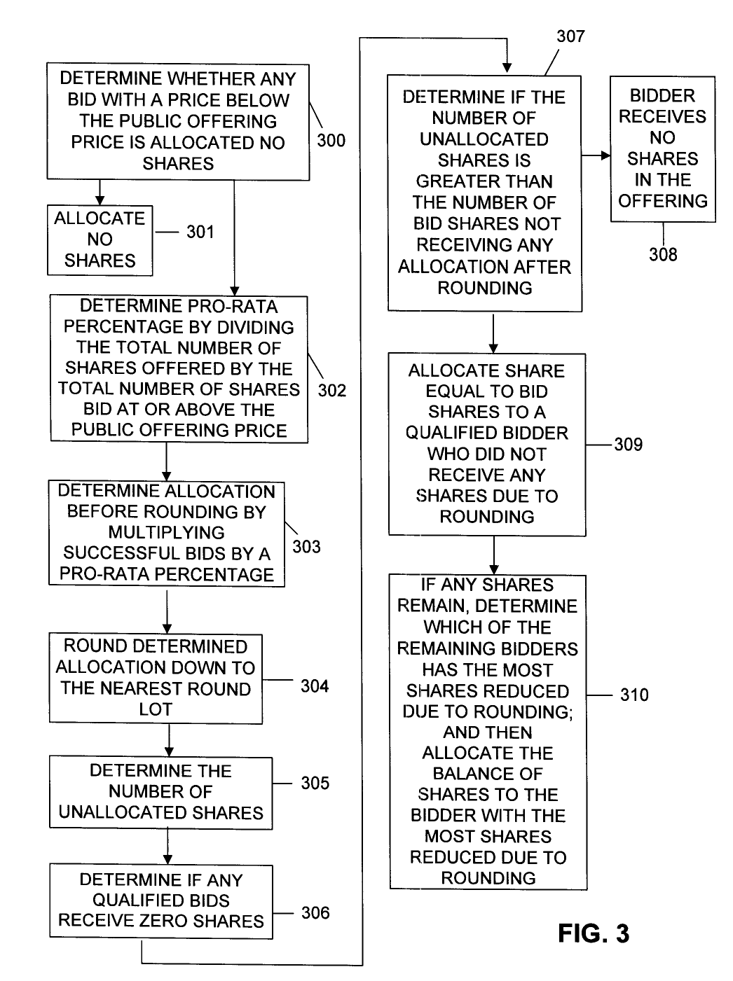

FIG. 3 is a flow diagram illustrating an embodiment of an exchange-based auction method for determining the allocation of shares in a public offering.

Generally the allocation of shares in this offering will be determined in the following manner, continuing the first example above:
In operations 300 and 301, any bid with a price below the public offering price is allocated no shares.
In operation 302, the pro-rata percentage is determined by dividing the number of shares offered (including the over-allotment option) by the total number of shares bid at or above the public offering price. In our example, if there are 2,000 shares bid for at or above the public offering price, and 1,500 shares offered in the offering, then the pro-rata percentage is 75%.
In operation 303, all of the successful bids are then multiplied by the pro-rata percentage to determine the allocations before rounding. For example, the three winning bids for 1,000 shares (Bid 1), 100 shares (Bid 2) and 900 shares (Bid 3) would initially be allocated 750 shares, 75 shares and 675 shares, respectively, based on the pro rata percentage.
In operation 304, the bids are then rounded down to the nearest 100 share round lot, so the bids would be rounded to 700, 0 and 600 shares respectively. In operation 305, the underwriter or issuer determines the number of unallocated shares. This creates a stub of 200 unallocated shares.
The 200 stub shares are then allocated to the bids. In operation 306, the underwriter or issuer determines if any qualified bids receive zero shares. Continuing the example above, because Bid 2 for 100 shares was rounded down to 0 shares, 100 of the stub shares would be allocated to Bid 2. In operations 307 and 308, if there were not sufficient stub shares to allocate at least 100 shares to Bid 2, Bid 2 would not receive any shares in the offering. After allocation of these shares, 100 unallocated stub shares would remain.
In operation 309, because Bid 3 for 900 shares was reduced, as a result of rounding, by more total shares than Bid 1 for 1,000 shares, Bid 3 would then be allocated the remaining 100 stub shares up to the nearest 100 round lot (from 600 shares to 700 shares).

In operation 310, if there are not sufficient remaining stub shares to enable a bid to be rounded up to a round lot of 100 shares the remaining unallocated stub shares would be allocated to smaller orders that are below their bid amounts. The table below illustrates the allocations in the example above.

Initial Public Offering of Company X

| | | Pro-rata | | | |
|---|---|---|---|---|---|
| | | Allocation | | | |
| | | (75% of | Initial | Allocation | Final |
| | Initial bid | Initial bid) | rounding | of stub shares | allocation |
| Bid 1 | 1,000 | 750 | 700 | 0 | 700 |
| Bid 2 | 100 | 75 | 0 | 100 | 100 |
| Bid 3 | 900 | 675 | 600 | 100 | 700 |
| Total | 2,000 | 1,500 | 1,300 | 200 | 1,500 |

A variety of modifications to the embodiments described will be apparent to those skilled in the art from the disclosure provided herein. Thus, the invention may be embodied in other specific forms without departing from the spirit or essential attributes thereof and, accordingly, reference should be made to the appended claims, rather than to the foregoing specification, as indicating the scope of the invention.

We claim:

1. A method to implement an exchange-based auction for offerings of securities connected on a communication network, comprising:
conducting an auction via an exchange, the exchange configured to comprise qualified individual and institutional investors placing bids in the auction;
permitting investors within the conducted auction to submit valid bids in order to receive an allocation of securities; and
determining an offering price and corresponding allocation of securities associated with the auction based on the submitted valid bids.

2. The method of claim 1, wherein the offering price and allocation of securities comprises initial and secondary public offering price and allocation of securities.

3. The method of claim 1, wherein the qualified individual and institutional investors are determined by at least one of the exchange, the underwriter and/or the issuer.

4. The method of claim 1, wherein the exchange is configured to monitoring the submission of valid bids in order to facilitate an equal probability of investors receiving allocation of securities based on the respective bids of the investors.

5. The method of claim 1, further comprising:
determining when a registration statement associated with an offering becomes effective;
determining when a preliminary prospectus associated with the offering is available;
opening an auction by an issuer of the securities prior to the effective determination of the registration statements and after the available determination of the preliminary prospectus.

6. The method of claim 1, wherein the exchange comprises (i) a U.S. or foreign marketplace for securities or any financial instruments, including without limitation, any exchange, organization, association or group of persons, whether incorporated or unincorporated, that constitute, maintain or provide a marketplace or facilities for bringing together buyers and sellers of securities, futures and/or other financial instruments, for bringing together orders for securities, futures and/or financial instruments of multiple buyers and sellers, or for otherwise performing with respect to securities, futures and/or other financial instruments the functions commonly performed by a stock exchange, commodity exchange, trading center, alternative trading system, trade reporting system, alternative display facility, automated trading center, electronic communications network or other similar facility as those terms are respectively generally understood; (ii) any U.S. and foreign quotation and trade reporting system or any other similar facility or market center where orders to buy and sell securities, futures and/or other financial instruments interact with each other; (iii) any exchange, quotation system, trading center, alternative trading system, alternative display facility, automated trading center, electronic communications network or other facility and any market facility maintained by any of the foregoing; and/or (iv) any U.S. and foreign over-the-counter market, including, without limitation, any in-person, telephone, computer or other electronic network that connects buyers and sellers of securities, futures and/or other financial instruments.

7. A method to implement an exchange-based auction for offerings connected on a communication network, comprising:
inputting bids and offers, the inputted bids configured to correspond to non-binding indications of interest to participate in an offering;
routing the inputted bids and offers to an exchange;
providing access to the routed inputted bids to an underwriter conducting an auction associated with the bids and offers; and
employing a scoring technique controlled by the underwriter and an issuer in order to rate a quality of indication of interest inputted by bidders.

8. The method of claim 7, further comprising:
permitting the underwriter to determine a clearing price, offering price, and/or duration of the auction period; and
providing the underwriter and/or an issuer with access to review the submitted bids.

9. The method of claim 8, wherein the bid comprises a number of securities of the issuer that an investor proposes to purchase based on an indication of interest by the investor, and the price the investor is willing to pay for the securities.

10. The method of claim 7, further comprising:
permitting the underwriter to set a minimum bid size available to potential investors.

11. The method of claim 7, wherein the scoring technique comprises performing a qualitative and/or quantitative analysis of information associated with each of the bidders and their respective bids.

12. The method of claim 11, further comprising:
allocating a score to each of the bidders based on the performed qualitative and/or quantitative analysis; and
comparing the allocated scores associated with each of the bidders.

13. The method of claim 7, further comprising:
eliminating bidders falling below a predetermined threshold from purchasing securities allocated the underwriter and/or issuer based on the employed scoring technique; and
permitting bidders rising above the predetermined threshold to purchase a percentage of the bid inputted by each of the respective bidders, the purchase percentage configured to be based on the employed scoring technique.

14. The method of claim 9, further comprising:
transmitting notice to the investors indicating a proposed effective date of a registration statement associated with the offering.

15. The method of claim 14, further comprising:
receiving notice by the investors corresponding to the registration statement associated with the offering;
contacting the investors by underwriters controlling the process of the bids; and
advising each investor of whether the registration statement is declared effective based on previously submitted bids associated with each investor.

16. The method of claim 15, further comprising:
advising each investor of a predetermined time when the auction closes subsequent to the declaration of effectiveness; and
permitting bidders to withdraw their bids within the advised predetermined time.

17. The method of claim 16, further comprising:
determining whether a predetermined condition occurred; and
requiring bidders to reconfirm submitted bids associated with each of the bidders based on the occurrence of the predetermined condition.

18. The method of claim 17, wherein the predetermined condition comprises:
calculating the number of elapsed business days since each bidder submitted bids associated with an offering;
determining whether a material change occurred resulting in a prospectus recirculation of by an issuer and the underwriters; and
determining whether the initial public offering is, a predetermined percentage above a preset high end of a price range for securities associated with the offering, or whether the predetermined percentage is below a preset low end of a price range.

19. A method to implement an exchange-based auction for offerings connected on a communication network, comprising:
determining a public offering price at which all securities are offered based on results of all submitted valid bids prior to closing of the auction;
allocating securities to at least one potential investor based on the determined public offering price, wherein all valid bids submitted by the at least one potential investor at or above the public offering price receives a pro rata portion of bid securities occurring during the auction;
accepting successful bids by sending notice of acceptance subsequent to the determination of the public offering price and after the closing of the auction.

20. The method of claim 19, further comprising:
evaluating whether to allocate to the at least one potential investor fewer securities than the number of securities bid by the at least one potential investor based on the valid bids submitted by the potential investor.

21. The method of claim 19, wherein the determining a public offering price comprises:
offering to sell a predetermined number of securities in a public offering;
receiving bids to purchase the offered predetermined number of securities, the received bids configured to be maintained in a confidential status until the auction is closed;
ascertaining a clearing price of the auction based on the highest price offered for all securities associated with the purchased received bids in order to cover overallotments, and all other securities are offered;
generating a public offering price based on the ascertained clearing price.

22. The method of claim 19, further comprising:
rejecting potential investors falling below a predetermined threshold from purchasing securities offered for sale in the public offering based on an employed scoring technique;
permitting potential investors rising above the predetermined threshold to purchase a percentage of the bid inputted by each of the respective bidders, the purchase percentage configured to be based on the employed scoring technique; and
allocating securities to at least one potential investor based on the determined public offering price, wherein all valid bids submitted by the at least one potential investor at or above the public offering price receives a pro rata portion of bid securities occurring during the auction.

23. The method of claim 22, further comprising:
rounding down any bid share amount to a nearest round lot in accordance with predetermined allocation rules.

24. The method of claim 19, wherein the allocating securities to at least one:
receiving an allocation of securities by the at least one potential investor on a round-lot basis, the round-lot configured to be in multiples of 100 and/or 1000 securities.

25. A system to implement an exchange-based auction for offerings connected on a computer network, comprising:
an auction mechanism for conducting an auction via an exchange, the exchange configured to comprise qualified individual and institutional investors placing bids in the auction;
a submission mechanism for permitting investors within the conducted auction to submit valid bids in order to receive an allocation of securities; and
a determination mechanism for determining a public offering price and corresponding allocation of securities associated with the auction based on the submitted valid bids.

26. The system of claim 25, wherein the public offering price and allocation of securities comprises initial and secondary public offering price and allocation of securities.

27. The system of claim 25, wherein the qualified individual and institutional investors comprises at least one underwriter and at least one issuer.

28. The system of claim 25, wherein the exchange is configured to monitoring the submission of valid bids in order to facilitate an equal probability of investors receiving allocation of securities based on the respective bids of the investors.

29. The system of claim 25, further comprising:
a first determination mechanism for determining when a registration statement associated with an offering becomes effective;
a second determination mechanism for determining when a preliminary prospectus associated with the offering is available;
an auction mechanism for opening an auction by an issuer of the securities prior to the effective determination of the registration statements and after the determination of the preliminary prospectus.

30. The system of claim 25, wherein the exchange comprises (i) a U.S. or foreign marketplace for securities or any financial instruments, including without limitation, any exchange, organization, association or group of persons., whether incorporated or unincorporated, that constitute, maintain or provide a marketplace or facilities for bringing together buyers and sellers of securities, futures and/or other financial instruments, for bringing together orders for securities, futures and/or financial instruments of multiple buyers and sellers, or for otherwise performing with respect to securities, futures and/or other financial instruments the functions commonly performed by a stock exchange, commodity exchange, trading center, alternative trading system, trade reporting system, alternative display facility, automated trading center, electronic communications network or other similar facility as those terms are respectively generally understood; (ii) any U.S. and foreign quotation and trade reporting system or any other similar facility or market center where orders to buy and sell securities, futures and/or other financial instruments interact with each other; (iii) any exchange, quotation system, trading center, alternative trading system, alternative display facility, automated trading center, electronic communications network or other facility and any market facility maintained by any of the foregoing; and/or (iv) any U.S. and foreign over-the-counter market, including, without limitation, any in-person, telephone, computer or other electronic network that connects buyers and sellers of securities, futures and/or other financial instruments.

31. A system to implement an exchange-based auction for offerings connected on a communication network, comprising:
an input mechanism for inputting bids and offers, the inputted bids configured to correspond to non-binding indications of interest to participate in an offering;
a routing mechanism for routing the inputted bids and offers to an exchange;
a filter mechanism for providing access to the routed inputted bids to an underwriter conducting an auction associated with the bids and offers; and
a scoring mechanism for employing a scoring technique controlled by the underwriter and an issuer in order to rate the quality of indication of interest inputted by bidders.

32. The system of claim 31, further comprising:
a first permission mechanism for permitting the underwriter to determine a clearing price, offering price, and/or duration of the auction period; and
an access mechanism for providing the underwriter and/or an issuer with access to review the submitted bids.

33. The system of claim 32, wherein the bid comprises a number of securities of the issuer that an investor proposes to purchase based on an indication of interest by the investor, and the price the investor is willing to pay for the securities.

34. The system of claim 31, further comprising:
a second permission mechanism for permitting the underwriter to set a minimum bid size available to potential investors.

35. The system of claim 31, wherein the scoring technique comprises performing a qualitative and/or quantitative analysis of information associated with each of the bidders and their respective bids.

36. The system of claim 35, further comprising:
an allocation mechanism for allocating a score to each of the bidders based on the performed qualitative and/or quantitative analysis; and
a comparison mechanism for comparing the allocated scores associated with each of the bidders.
